(19) United States
(12) Patent Application Publication
(10) Pub. No.: US 2025/0244880 A1
(43) Pub. Date: Jul. 31, 2025

(54) WEAR LEVELING METHOD, MEMORY STORAGE DEVICE, AND MEMORY CONTROL CIRCUIT UNIT

(71) Applicant: Hefei Core Storage Electronic Limited, Anhui (CN)

(72) Inventors: Wan-Jun Hong, Anhui (CN); Xu Hui Cheng, Anhui (CN); Tsung-Lin Wu, Hsinchu City (TW); Qi-Ao Zhu, Anhui (CN); Chong Peng, Anhui (CN)

(73) Assignee: Hefei Core Storage Electronic Limited, Anhui (CN)

(21) Appl. No.: 18/809,344

(22) Filed: Aug. 20, 2024

(30) Foreign Application Priority Data
Jan. 25, 2024 (CN) 202410101917.4

(51) Int. Cl. G06F 3/06

(52) U.S. Cl. CPC G06F 3/0616; G06F 3/0647; G06F 3/0679

(57) ABSTRACT

The invention provides a wear leveling method, a memory storage device, and a memory control circuit unit. The method includes: recording wear count values respectively corresponding to a plurality of physical units; obtaining a total of a plurality of first physical units, wherein a first wear count value corresponding to each of the first physical units meets a first condition; triggering a wear leveling operation in response to the total meeting a second condition; and in the wear leveling operation, moving valid data in at least one second physical unit to at least one of the plurality of first physical units. As a result, the wear leveling operation performed on the rewritable non-volatile memory module may be optimized.

### CROSS-REFERENCE TO RELATED APPLICATION

This application claims the priority benefit of China application serial no. 202410101917.4, filed on Jan. 25, 2024. The entirety of the above-mentioned patent application is hereby incorporated by reference herein and made a part of this specification.

### BACKGROUND OF THE INVENTION

### Field of the Invention

The invention relates to a memory management technique, and in particular to a wear leveling method, a memory storage device, and a memory control circuit unit.

### Description of Related Art

Smartphones, tablet computers, and notebook computers have grown rapidly in recent years, causing consumer demand for storage media to also increase rapidly. Since a rewritable non-volatile memory module (for example, flash memory) has characteristics such as data non-volatility, power saving, and small size, as well as lack of mechanical structure, the rewritable non-volatile memory module is very suitable to be built into various portable multimedia devices as exemplified above.

Generally, after a rewritable non-volatile memory module is used for a period of time, the physical blocks in the rewritable non-volatile memory module often suffer from uneven wear. For example, in a rewritable non-volatile memory module adopting classified storage of hot and cold data, the degree of wear of physical blocks used for storing hot data is increased faster, and the degree of wear of physical blocks used for storing cold data is not readily increased. When the degree of wear of certain physical blocks is too high, these physical blocks may readily become bad blocks, thereby shortening the service life of the rewritable non-volatile memory module. Therefore, common memory management strategies include performing wear leveling (WL) on the physical blocks having the highest (relatively higher) and lowest (relatively lower) wear levels in the rewritable non-volatile memory module, so that the distribution of the overall degree of wear of the rewritable non-volatile memory module is more uniform.

However, the technical objects of current wear leveling techniques are all focused on improving the selection strategy of physical blocks for which wear leveling needs to be performed during a wear leveling operation, thus ignoring too frequent execution of wear leveling that may cause issues such as excessive write amplification to the rewritable non-volatile memory module that as a result shortens the service life of the rewritable non-volatile memory module.

### SUMMARY OF THE INVENTION

The invention provides a wear leveling method, a memory storage device, and a memory control circuit unit that may optimize a wear leveling operation performed on a rewritable non-volatile memory module to extend the service life of the rewritable non-volatile memory module.

An exemplary embodiment of the invention provides a wear leveling method, used for a rewritable non-volatile memory module, wherein the rewritable non-volatile memory module includes a plurality of physical units, and the wear leveling method includes: recording wear count values respectively corresponding to the plurality of physical units; obtaining a total of a plurality of first physical units in the plurality of physical units, wherein a first wear count value corresponding to each of the first physical units meets a first condition; triggering a wear leveling operation in response to the total meeting a second condition; and moving valid data in at least one second physical unit in the plurality of physical units to at least one of the plurality of first physical units in the wear leveling operation, wherein a second wear count value corresponding to each of the second physical units is less than the first wear count value.

An exemplary embodiment of the invention further provides a memory storage device including a connection interface unit, a rewritable non-volatile memory module, and a memory control circuit unit. The connection interface unit is used for connecting to a host system. The rewritable non-volatile memory module includes a plurality of physical units. The memory control circuit unit is connected to the connection interface unit and the rewritable non-volatile memory module. The memory control circuit unit is used for: recording wear count values respectively corresponding to the plurality of physical units; obtaining a total of a plurality of first physical units in the plurality of physical units, wherein a first wear count value corresponding to each of the first physical units meets a first condition; triggering a wear leveling operation in response to the total meeting a second condition; and moving valid data in at least one second physical unit in the plurality of physical units to at least one of the plurality of first physical units in the wear leveling operation, wherein a second wear count value corresponding to each of the second physical units is less than the first wear count value.

An exemplary embodiment of the invention further provides a memory control circuit unit for controlling a rewritable non-volatile memory module, wherein the rewritable non-volatile memory module includes a plurality of physical units. The memory control circuit unit includes a host interface, a memory interface, and a memory management circuit. The host interface is used for connecting to a host system. The memory interface is used for connecting to the rewritable non-volatile memory module. The memory management circuit is connected to the host interface and the memory interface. The memory management circuit is used for: recording wear count values respectively corresponding to the plurality of physical units; obtaining a total of a plurality of first physical units in the plurality of physical units, wherein a first wear count value corresponding to each of the first physical units meets a first condition; triggering a wear leveling operation in response to the total meeting a second condition; and moving valid data in at least one second physical unit in the plurality of physical units to at least one of the plurality of first physical units in the wear leveling operation, wherein a second wear count value corresponding to each of the second physical units is less than the first wear count value.

Based on the above, after the wear count values respectively corresponding to the plurality of physical units in the rewritable non-volatile memory module are recorded, the total of the plurality of first physical units may be obtained, and the first wear count value corresponding to each of the first physical units meets the first condition. Thereafter, in response to the total meeting the second condition, the wear leveling operation may be triggered, so that in the wear leveling operation, valid data in the second physical unit having a smaller wear count value is moved to the first physical units. As a result, the wear leveling operation performed on the rewritable non-volatile memory module may be optimized, thereby extending the service life of the rewritable non-volatile memory module.

### BRIEF DESCRIPTION OF THE DRAWINGS

FIG. 1 is a schematic diagram of a host system, a memory storage device, and an input/output (I/O) device shown according to an exemplary embodiment of the invention.

FIG. 2 is a schematic diagram of a host system, a memory storage device, and an I/O device shown according to an exemplary embodiment of the invention.

FIG. 3 is a schematic diagram of a host system and a memory storage device shown according to an exemplary embodiment of the invention.

FIG. 4 is a schematic diagram of a memory storage device shown according to an exemplary embodiment of the invention.

FIG. 5 is a schematic diagram of a memory control circuit unit shown according to an exemplary embodiment of the invention.

FIG. 6 is a schematic diagram of managing a rewritable non-volatile memory module shown according to an exemplary embodiment of the invention.

FIG. 7 is a schematic diagram of the distribution of wear count values of physical units shown according to an exemplary embodiment of the invention.

FIG. 8 is a flowchart of a wear leveling method shown according to an exemplary embodiment of the invention.

### DESCRIPTION OF THE EMBODIMENTS

Hereinafter, reference will be made in detail to exemplary embodiments of the invention, and examples of the exemplary embodiments are illustrated in the figures. Wherever possible, the same reference numerals are used in the figures and the in descriptions to refer to the same or similar portions.

Generally, a memory storage device (also referred to as a memory storage system) includes a rewritable non-volatile memory module and a controller (also referred to as a control circuit). The memory storage device may be used with a host system such that the host system may write data to the memory storage device or read data from the memory storage device.

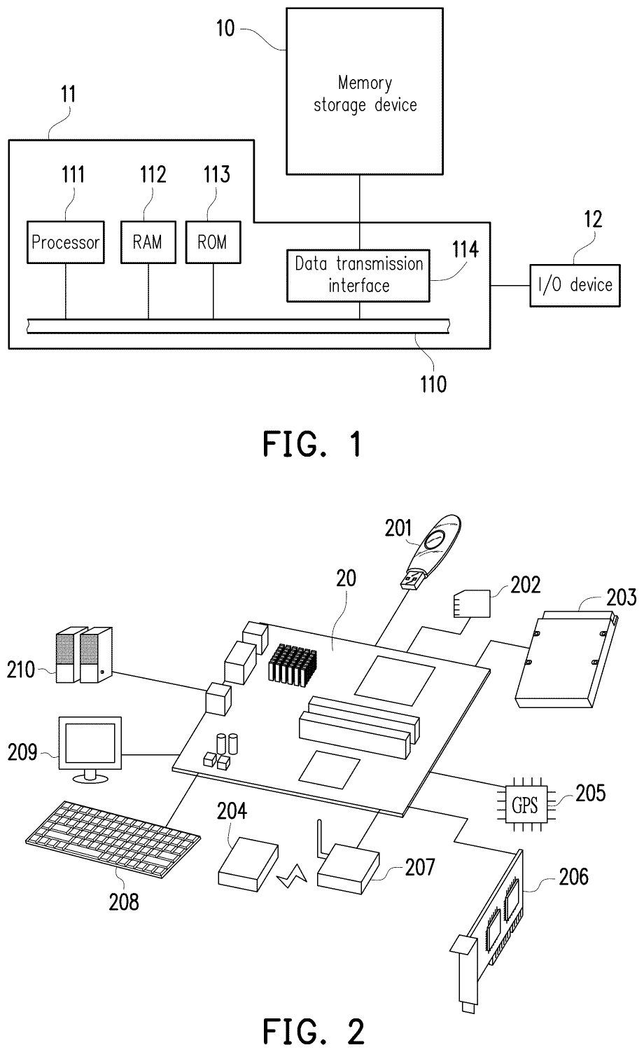

FIG. 1 is a schematic diagram of a host system, a memory storage device, and an input/output (I/O) device shown according to an exemplary embodiment of the invention. FIG. 2 is a schematic diagram of a host system, a memory storage device, and an I/O device shown according to an exemplary embodiment of the invention.

Referring to FIGS. 1 and 2, a host system 11 may include a processor 111, a random-access memory (RAM) 112, a read-only memory (ROM) 113, and a data transmission interface 114. The processor 111, the random-access memory 112, the read-only memory 113, and the data transmission interface 114 may be connected to a system bus 110.

In an exemplary embodiment, the host system 11 may be connected to the memory storage device 10 via the data transmission interface 114. For example, the host system 11 may store data to the memory storage device 10 or read data from the memory storage device 10 via the data transmission interface 114. In addition, the host system 11 may be connected to the I/O device 12 via the system bus 110. For example, the host system 11 may transmit an output signal to the I/O device 12 or receive an input signal from the I/O device 12 via the system bus 110.

In an exemplary embodiment, the processor 111, the random-access memory 112, the read-only memory 113, and the data transmission interface 114 may be disposed on a motherboard 20 of the host system 11. The number of the data transmission interface 114 may be one or a plurality. Via the data transmission interface 114, the motherboard may be connected to the memory storage device 10 in a wired or wireless manner.

In an exemplary embodiment, the memory storage device 10 may be, for example, a USB flash drive 201, a memory card 202, a solid-state drive (SSD) 203, or a wireless memory storage device 204. The wireless memory storage device 204 may be, for example, a memory storage device based on various wireless communication techniques such as a Near-Field Communication (NFC) memory storage device, a wireless fax (WiFi) memory storage device, a Bluetooth memory storage device, or a low-energy Bluetooth memory storage device (e.g., iBeacon). Moreover, the motherboard 20 may also be connected to various I/O devices such as a global positioning system (GPS) module 205, a network interface card 206, a wireless transmission device 207, a keyboard 208, a screen 209, and a speaker 210 via the system bus 110. For example, in an exemplary embodiment, the motherboard 20 may access the wireless memory storage device 204 via the wireless transmission device 207.

In an exemplary embodiment, the host system 11 is a computer system. In an exemplary embodiment, the host system 11 may be substantially any system that may cooperate with a memory storage device to store data. In an exemplary embodiment, the memory storage device 10 and the host system 11 may include a memory storage device and a host system 31 of FIG. 3 respectively.

FIG. 3 is a schematic diagram of a host system and a memory storage device shown according to an exemplary embodiment of the invention. Referring to FIG. 3, the memory storage device 30 may be used in conjunction with the host system 31 to store data. For example, the host system 31 may be a digital camera, a video camera, a communication device, an audio player, a video player, or a tablet computer. For example, the memory storage device 30 may be various non-volatile memory storage devices such as a Secure Digital (SD) card 32, a Compact Flash (CF) card 33, or an embedded storage device 34 used by the host system 31. The embedded storage device 34 includes various types of embedded storage devices that connect memory modules directly to the substrate of the host system, such as an embedded multimedia card (eMMC) 341 and/or an embedded multi chip package (eMCP) storage device 342.

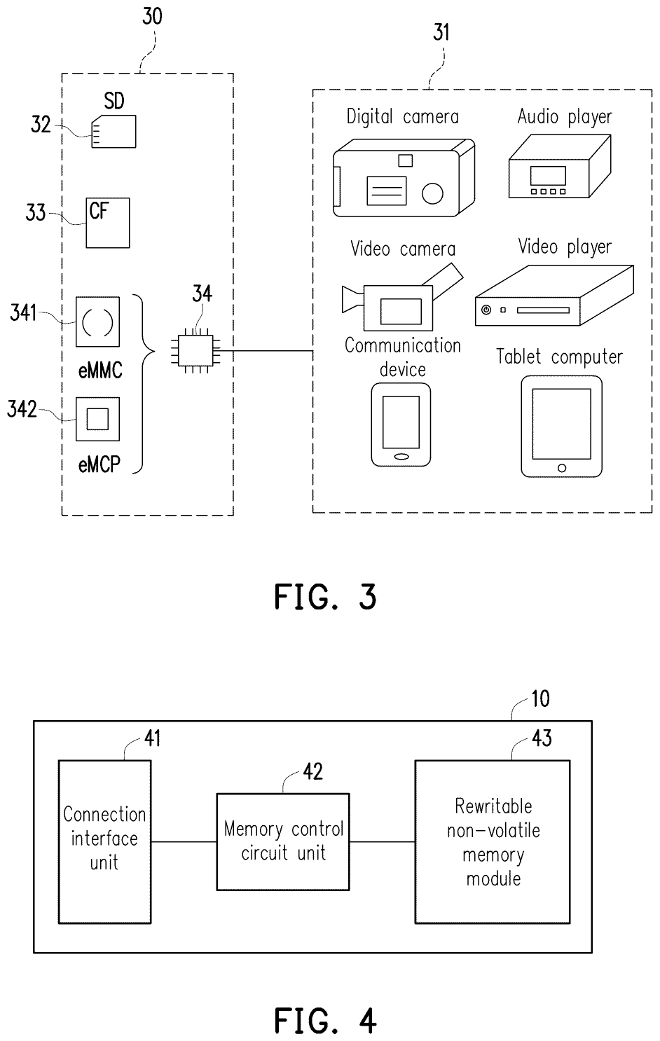

FIG. 4 is a schematic diagram of a memory storage device shown according to an exemplary embodiment of the invention. Referring to FIG. 4, the memory storage device 10 includes a connection interface unit 41, a memory control circuit unit 42, and a rewritable non-volatile memory module 43.

The connection interface unit 41 is used for connecting the memory storage device 10 to the host system 11. The memory storage device 10 may communicate with the host system 11 via the connection interface unit 41. In an exemplary embodiment, the connection interface unit 41 is compatible with the Peripheral Component Interconnect Express (PCI Express) standard. However, it needs to be understood that the invention is not limited thereto, and the connection interface unit 41 may also comply with the Serial Advanced Technology Attachment (SATA) standard, Parallel Advanced Technology Attachment (PATA) standard, Institute of Electrical and Electronic Engineers (IEEE) 1394 standard, Universal Serial Bus (USB) standard, SD interface standard, Ultra High Speed-I (UHS-I) interface standard, Ultra High Speed-II (UHS-II) interface standard, Memory Stick (MS) interface standard, MCP interface standard, MMC interface standard, eMMC interface standard, Universal Flash Storage (UFS) interface standard, eMCP interface standard, CF interface standard, Integrated Device Electronics (IDE) standard, or other suitable standards. The connection interface unit 41 and the memory control circuit unit 42 may be packaged in one chip, or the connection interface unit 41 may be arranged outside a chip containing the memory control circuit unit 42.

The memory control circuit unit 42 is connected to the connection interface unit 41 and the rewritable non-volatile memory module 43. The memory control circuit unit 42 is used for executing a plurality of logic gates or control instructions implemented in hardware or firmware and performing an operation such as data writing, reading, and erasing in the rewritable non-volatile memory module 43 according to the instructions of the host system 11.

The rewritable non-volatile memory module 43 is used for storing data written by the host system 11. The rewritable non-volatile memory module 43 may include a single-level cell (SLC) NAND-type flash memory module (that is, a flash memory module that may store 1 bit in one memory cell), a multi-level cell (MLC) NAND-type flash memory module (that is, a flash memory module that may store 2 bits in one memory cell), a triple level cell (TLC) NAND-type flash memory module (that is, a flash memory module that may store 3 bits in one memory cell), a quad level cell (QLC) NAND-type flash memory module (that is, a flash memory module that may store 4 bits in one memory cell), other flash memory modules, or other memory modules having the same characteristics.

Each memory cell in the rewritable non-volatile memory module 43 stores one or a plurality of bits based on changes in voltage (hereinafter also referred to as critical voltage). Specifically, there is a charge-trapping layer between the control gate and the channel of each of the memory cells. By applying a write voltage to the control gate, the number of electrons in the charge-trapping layer may be changed, thereby changing the critical voltage of the memory cell. This operation of changing the critical voltage of the memory cell is also referred to as “writing data to the memory cell” or “programming the memory cell.” As the critical voltage is changed, each of the memory cells in the rewritable non-volatile memory module 43 has a plurality of memory states. By applying a read voltage, it may be determined which storage state a memory cell belongs to, thereby obtaining one or a plurality of bits stored in the memory cell.

In an exemplary embodiment, the memory cells of the rewritable non-volatile memory module 43 may constitute a plurality of physical programming units, and these physical programming units may constitute a plurality of physical erasing units. Specifically, memory cells on the same word line may form one or a plurality of physical programming units. If each of the memory cells may store 2 or more bits, the physical programming units on the same word line may be at least classified into lower physical programming units and upper physical programming units. For example, the least significant bit (LSB) of a memory unit belongs to the lower physical programming units, and the most significant bit (MSB) of a memory unit belongs to the upper physical programming units. Generally, in an MLC NAND-type flash memory, the write speed of the lower physical programming units is greater than the write speed of the upper physical programming units, and/or the reliability of the lower physical programming units is higher than the reliability of the upper physical programming units.

In an exemplary embodiment, the physical programming unit is the smallest unit of programming. That is, the physical programming unit is the smallest unit for writing data. For example, the physical programming unit may be a physical page or a physical sector. If the physical programming unit is a physical page, this physical programming unit may include a data bit area and a redundancy bit area. The data bit area contains a plurality of physical sectors to store user data, and the redundancy bit area is used for storing system data (for example, management data such as error correcting code). In an exemplary embodiment, the data bit area contains 32 physical sectors, and the size of one physical sector is 512 bytes (B). However, in other exemplary embodiments, the data bit area may also contain 8, 16, or more or less physical sectors, and the size of each of the physical sectors may also be greater or less. Moreover, the physical erasing unit is the smallest unit of erasing. That is, each of the physical erasing units contains a minimum number of memory cells erased together. For example, the physical erasing unit is a physical block.

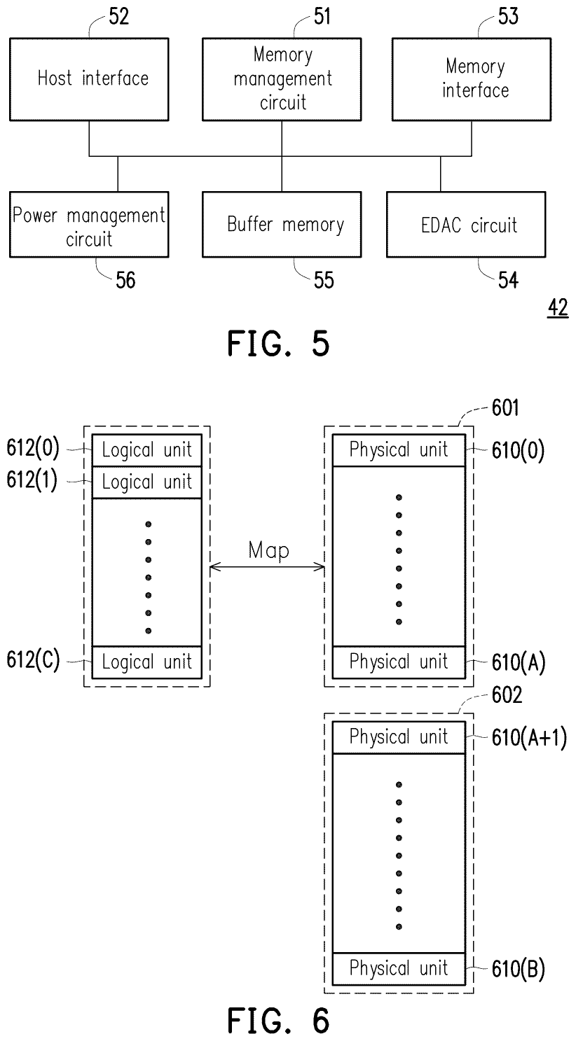

FIG. 5 is a schematic diagram of a memory control circuit unit shown according to an exemplary embodiment of the invention. Please refer to FIG. 5, the memory control circuit unit 42 includes a memory management circuit 51, a host interface 52, a memory interface 53, and an error detection and correction (EDAC) circuit 54.

The memory management circuit 51 is used for controlling the overall operation of the memory control circuit unit 42. Specifically, the memory management circuit 51 has a plurality of control instructions, and when the memory storage device 10 is in operation, these control instructions are executed to perform an operation such as data writing, reading, erasing. When the operation of the memory management circuit 51 is described below, it is equivalent to describing the operation of the memory control circuit unit 42.

In an exemplary embodiment, the control instructions of the memory management circuit 51 are implemented in firmware form. For example, the memory management circuit 51 has a microprocessor unit (not shown) and a read-only memory (not shown), and these control instructions are burned into the read-only memory. When the memory storage device 10 is in operation, these control instructions are executed by the microprocessor unit to perform an operation such as data writing, reading, erasing.

In an exemplary embodiment, the control instructions of the memory management circuit 51 may also be stored in a specific area of the rewritable non-volatile memory module 43 (for example, a system area in the memory module dedicated to storing system data) in the form of program code. In addition, the memory management circuit 51 has a microprocessor unit (not shown), a read-only memory (not shown), and a random-access memory (not shown). In particular, this read-only memory has a boot code, and when the memory control circuit unit 42 is enabled, the microprocessor unit first executes the boot code to load the control instructions stored in the rewritable non-volatile memory module 43 into the random-access memory of the memory management circuit 51. Then, the microprocessor unit runs these control instructions to perform an operation such as data writing, reading, and erasing.

In an exemplary embodiment, the control instructions of the memory management circuit 51 may also be implemented in a hardware form. For example, the memory management circuit 51 includes a microcontroller, a memory unit management circuit, a memory writing circuit, a memory reading circuit, a memory erasing circuit, and a data processing circuit. The memory unit management circuit, the memory writing circuit, the memory reading circuit, the memory erasing circuit, and the data processing circuit are connected to the microcontroller. The memory cell management circuit is used for managing the memory cells or memory cell groups of the rewritable non-volatile memory module 43. The memory writing circuit is used for issuing a write instruction sequence to the rewritable non-volatile memory module 43 to write data into the rewritable non-volatile memory module 43. The memory reading circuit is used for issuing a read instruction sequence to the rewritable non-volatile memory module 43 to read data from the rewritable non-volatile memory module 43. The memory erasing circuit is used for issuing an erasing instruction sequence to the rewritable non-volatile memory module 43 to erase data from the rewritable non-volatile memory module 43. The data processing circuit is used for processing data to be written to the rewritable non-volatile memory module 43 and data to be read from the rewritable non-volatile memory module 43. The write command sequence, the read command sequence, and the erase command sequence may each include one or a plurality of program codes or instruction codes and be used for instructing the rewritable non-volatile memory module 43 to perform a corresponding operation such as writing, reading, and erasing. In an exemplary embodiment, the memory management circuit 51 may also issue other types of instruction sequences to the rewritable non-volatile memory module 43 to instruct the execution of corresponding operations.

The host interface 52 is connected to the memory management circuit 51. The memory management circuit 51 may communicate with the host system 11 via the host interface 52. The host interface 52 may be used for receiving and identifying instructions and data transmitted by the host system 11. For example, instructions and data transmitted by the host system 11 may be transmitted to the memory management circuit 51 via the host interface 52. In addition, the memory management circuit 51 may transmit data to the host system 11 via the host interface 52. In the present exemplary embodiment, the host interface 52 is compatible with the PCI Express standard. However, it needs to be understood that the invention is not limited thereto. The host interface 52 may also be compatible with the SATA standard, PATA standard, IEEE 1394 standard, USB standard, SD standard, UHS-I standard, UHS-II standard, MS standard, MMC standard, eMMC standard, UFS standard, CF standard, IDE standard, or other suitable data transmission standards.

The memory interface 53 is connected to the memory management circuit 51 and used for accessing the rewritable non-volatile memory module 43. For example, the memory management circuit 51 may access the rewritable non-volatile memory module 43 via the memory interface 53. That is, the data to be written to the rewritable non-volatile memory module 43 is converted into a format acceptable to the rewritable non-volatile memory module 43 via the memory interface 53. Specifically, if the memory management circuit 51 is to access the rewritable non-volatile memory module 43, the memory interface 53 transmits a corresponding instruction sequence. For example, the instruction sequence may include a write instruction sequence instructing to write data, a read instruction sequence instructing to read data, an erase instruction sequence instructing to erase data, and a corresponding instruction sequence instructing various memory operations (e.g., changing a read voltage level or performing a garbage collection operation, etc.) These instruction sequences are, for example, generated by the memory management circuit 51 and transmitted to the rewritable non-volatile memory module 43 via the memory interface 53. These instruction sequences may include one or a plurality of signals, or data on the bus. These signals or data may include instruction codes or program codes. For example, the read instruction sequence includes information such as read identification code and memory address.

The EDAC circuit 54 is connected to the memory management circuit 51 and is used for performing an error detection and correction operation to ensure the accuracy of data. Specifically, when the memory management circuit 51 receives a write instruction from the host system 11, the EDAC circuit 54 generates a corresponding error correcting code (ECC) and/or error detecting code (EDC) for the data corresponding to the write command, and the memory management circuit 51 writes the data corresponding to the write command and the corresponding error correcting code and/or error detecting code into the rewritable non-volatile memory module 43. Then, when the memory management circuit 51 reads data from the rewritable non-volatile memory module 43, the memory management circuit 51 reads the error correcting code and/or the error detecting code corresponding to the data at the same time, and the EDAC circuit 54 performs an EDAC operation on the read data according to the error correcting code and/or the error detecting code.

In an exemplary embodiment, the memory control circuit unit 42 further includes a buffer memory 55 and a power management circuit 56. The buffer memory 55 is connected to the memory management circuit 51 and used for temporarily storing data. The power management circuit 56 is connected to the memory management circuit 51 and used for controlling the power supply of the memory storage device 10.

In an exemplary embodiment, the rewritable non-volatile memory module 43 of FIG. 4 may include a flash memory module. In an exemplary embodiment, the memory control circuit unit 42 of FIG. 4 may include a flash memory controller. In an exemplary embodiment, the memory management circuit 51 of FIG. 5 may include a flash memory management circuit.

FIG. 6 is a schematic diagram of managing a rewritable non-volatile memory module shown according to an exemplary embodiment of the invention. Referring to FIG. 6, the memory management circuit 51 may logically group physical units 610(0) to 610(B) in the rewritable non-volatile memory module 43 into a storage area 601 and a spare area 602.

In an exemplary embodiment, one physical unit refers to one physical address or one physical programming unit. In an exemplary embodiment, one physical unit may also be composed of a plurality of consecutive or non-consecutive physical addresses. In an exemplary embodiment, one physical unit may also refer to one virtual block (VB). One virtual block may include a plurality of physical addresses or a plurality of physical programming units. In an exemplary embodiment, one virtual block may also include one or a plurality of physical blocks.

The physical units 610(0) to 610(A) in the storage area 601 are used for storing user data (for example, user data from the host system 11 of FIG. 1). For example, the physical units 610(0) to 610(A) in the storage area 601 may store valid data and invalid data. The physical units 610(A+1) to 610(B) in the spare area 602 do not store data (e.g., valid data). For example, if a certain physical unit does not store valid data, this physical unit may be associated (or added) to the spare area 602. In addition, physical units in the spare area 602 (or physical units that do not store valid data) may be erased. As new data is written, one or a plurality of physical units may be extracted from the spare area 602 to store the new data. In an exemplary embodiment, the spare area 602 is also referred to as a free pool.

The memory management circuit 51 may configure logical units 612(0) to 612(C) to map the physical units 610(0) to 610(A) in the storage area 601. In an exemplary embodiment, each logical unit corresponds to one logical address. For example, one logical address may include one or a plurality of logical block addresses (LBA) or other logical management units. In an exemplary embodiment, one logical unit may also correspond to one logical programming unit or be composed of a plurality of consecutive or non-consecutive logical addresses.

It should be noted that one logical unit may be mapped to one or a plurality of physical units. If a certain physical unit is currently mapped by a certain logical unit, it means that the data currently stored in this physical unit includes valid data. On the contrary, if a certain physical unit is not currently mapped by any logical unit, it means that the data currently stored in this physical unit is invalid data.

The memory management circuit 51 may record management data describing the mapping relationship between logical units and physical units (also referred to as logical-to-physical mapping information) in at least one logical-to-physical mapping table. When the host system 11 is to read data from or write data to the memory storage device 10, the memory management circuit 51 may access the rewritable non-volatile memory module 43 according to the information in the logical-to-physical mapping table.

In an exemplary embodiment, the memory management circuit 51 may record wear count values respectively corresponding to a plurality of physical units in the rewritable non-volatile memory module 43. For example, the wear count value corresponding to one physical unit may reflect the degree of wear of the physical unit. For example, the wear count value corresponding to one physical unit may be directly related to the degree of wear of the physical unit. That is, the greater the wear count value corresponding to one physical unit is, the higher the degree of wear of this physical unit is.

In an exemplary embodiment, the wear count value corresponding to one physical unit is related to the number of times the physical unit is erased, programmed, and/or read. For example, the wear count value corresponding to one physical unit may be directly related to the number of times the physical unit is erased, programmed, and/or read. That is, the greater the wear count value corresponding to one physical unit is, the higher the number of times the physical unit is erased, programmed, and/or read.

In an exemplary embodiment, the memory management circuit 51 may obtain the total of a specific physical unit (also referred to as a first physical unit) in the plurality of physical units. In particular, the wear count value (also referred to as a first wear count value) corresponding to each first physical unit needs to meet a specific condition (also referred to as a first condition). That is, if the wear count value corresponding to a certain physical unit meets the first condition, then this physical unit may be identified or marked as the first physical unit. However, if the wear count value corresponding to a certain physical unit does not meet the first condition, then this physical unit may be not identified or marked as the first physical unit.

In an exemplary embodiment, the first condition includes that the wear count value corresponding to the physical unit needs to be greater than one threshold value (also referred to as a first threshold value). That is, if the wear count value corresponding to a certain physical unit is greater than the first threshold value, then this physical unit may be identified or marked as the first physical unit. However, if the wear count value corresponding to a certain physical unit is not greater than the first threshold value, then this physical unit may not be identified or marked as the first physical unit. In an exemplary embodiment, the memory management circuit 51 may dynamically set the first threshold value.

In an exemplary embodiment, the first threshold value may be between the maximum wear count value and the average wear count value corresponding to the plurality of physical units in the rewritable non-volatile memory module 43. The maximum wear count value is the largest of wear count values respectively corresponding to a plurality of physical units in the rewritable non-volatile memory module 43. The average wear count value may reflect the average (or median) of the wear count values respectively corresponding to a plurality of physical units in the rewritable non-volatile memory module 43.

In an exemplary embodiment, the memory management circuit 51 may obtain one value (also referred to as a first value) according to the difference between the maximum wear count value and the average wear count value. It should be noted that the first value may be less than the difference. For example, the memory management circuit 51 may divide the difference value by N to obtain the first value, wherein N may be any value greater than 1. For example, assuming that the difference between the maximum wear count value and the average wear count value is K, the memory management circuit 51 may divide K by 2 or 3, and take the nearest integer (can be rounded up or down) to K/2 or K/3 as the first value.

In an exemplary embodiment, the memory management circuit 51 may obtain the first threshold value according to the average wear count value and the first value. In particular, the difference between the first threshold value and this average wear count value may be controlled (or influenced) by the first value. For example, the memory management circuit 51 may add the first value to the average wear count value to obtain the first threshold value. For example, the first threshold value may reflect the sum of the average wear count value and the first value. In an exemplary embodiment, by setting the first threshold value to be greater than the average wear count value, combined with the subsequent setting of trigger conditions for the wear leveling operation, the frequency with which the wear leveling operation is triggered may be reduced, and/or the number of physical units on which the wear leveling operation is performed each time may be reduced.

In an exemplary embodiment, as shown in Table 1, Table 1 is a schematic diagram of wear count values PE(1) to PE(30) of 30 physical units.

TABLE 1

| | | | | | |
|---|---|---|---|---|---|
| PE(1) = 150 [symbol] | PE(2) = 120 [symbol] | PE(3) = 130 [symbol] | PE(4) = 110 [symbol] | PE(5) = 140 [symbol] | PE(6) = 100 [symbol] |
| PE(7) = 180 [symbol] | PE(8) = 90 [symbol] | PE(9) = 150 [symbol] | PE(10) = 160 [symbol] | PE(11) = 130 [symbol] | PE(12) = 120 [symbol] |
| PE(13) = 110 [symbol] | PE(14) = 150 [symbol] | PE(15) = 80 [symbol] | PE(16) = 90 [symbol] | PE(17) = 100 [symbol] | PE(18) = 160 [symbol] |
| PE(19) = 170 [symbol] | PE(20) = 165 [symbol] | PE(21) = 170 [symbol] | PE(22) = 160 [symbol] | PE(23) = 140 [symbol] | PE(24) = 110 [symbol] |
| PE(25) = 120 [symbol] | PE(26) = 70 [symbol] | PE(27) = 60 [symbol] | PE(28) = 80 [symbol] | PE(29) = 90 [symbol] | PE(30) = 100 [symbol] |

In Table 1, the wear count value PE(i) represents the wear count value of the i-th physical unit (that is, the physical unit numbered “i”) in the 30 physical units. According to Table 1, it may be obtained that the maximum wear count value corresponding to these 30 physical units is “180” and the average wear count value corresponding to these 30 physical units is approximately “123”. The difference between the maximum wear count value and the average wear count value corresponding to these physical units is “57” (that is, K=57). In an exemplary embodiment, assuming N=2, the first value may be obtained according to K/2 to be approximately “28”, and the first threshold value may further be obtained as “151” (that is, 123+28=151). Or, in an exemplary embodiment, assuming N=3, the first value may be obtained according to K/3 to be “19”, and the first threshold value may further be obtained as “142” (that is, 123+19=142).

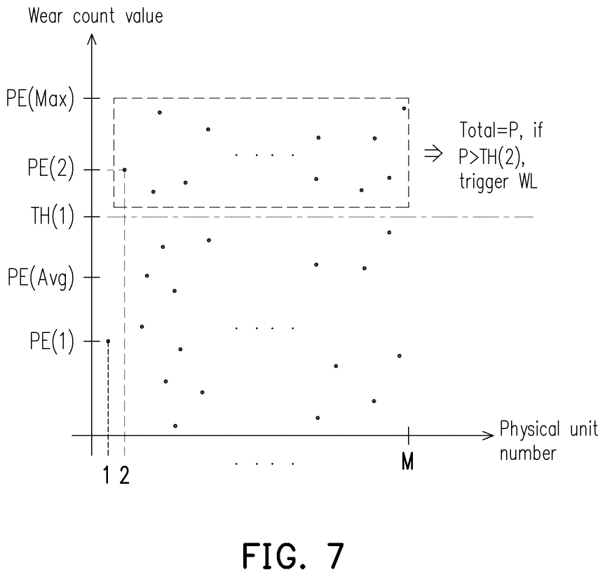

FIG. 7 is a schematic diagram of the distribution of wear count values of physical units shown according to an exemplary embodiment of the invention. Referring to FIG. 7, it is assumed that the rewritable non-volatile memory module 43 includes M physical units. Each physical unit corresponds to one wear count value. For example, the physical unit numbered “1” corresponds to the wear count value PE(1), the physical unit numbered “2” corresponds to the wear count value PE(2), and so on.

In the exemplary embodiment of FIG. 7, the wear count value PE(Max) is used to represent the maximum wear count value corresponding to the M physical units. The wear count value PE(Avg) is used to represent the average wear count value corresponding to these M physical units. In addition, the parameter TH(1) is used to represent the first threshold value. For example, the parameter TH(1) may be between the wear count values PE(Max) and PE(Avg). For example, the difference between the parameter TH(1) and the wear count value PE(Avg) may be controlled (or influenced) by the first value. For example, the first value may be obtained according to the difference between the wear count values PE(Max) and PE(Avg). The memory management circuit 51 may identify or mark the physical unit for which the corresponding wear count value is greater than the parameter TH(1) as the first physical unit.

In an exemplary embodiment, the memory management circuit 51 may determine whether the total of first physical units meets a specific condition (also referred to as a second condition). In response to the total of the first physical units meeting the second condition, the memory management circuit 51 may trigger a wear leveling (WL) operation. However, if the total of the first physical units does not meet the second condition, the memory management circuit 51 may not trigger the wear leveling operation.

In an exemplary embodiment, the memory management circuit 51 may determine whether the total of the first physical units is greater than one threshold value (also referred to as a second threshold value). For example, the second threshold value may be any integer greater than 1, and the second threshold value may be set or adjusted according to practical needs. In response to the total of the first physical units being greater than the second threshold value, the memory management circuit 51 may determine that the total of the first physical units meets the second condition. However, if the total of the first physical units is not greater than the second threshold value, the memory management circuit 51 may determine that the total of the first physical units does not meet the second condition.

Taking FIG. 7 as an example, it is assumed that the total of physical units (that is, first physical units) for which the corresponding wear count value is greater than the parameter TH(1) counted by the memory management circuit 51 is P. If P is greater than the parameter TH(2) (that is, the second threshold value), the memory management circuit 51 may determine that the total of the first physical units meets the second condition and actively trigger and perform a wear leveling operation. However, if P is not greater than the parameter TH(2), the memory management circuit 51 may determine that the total of the first physical units does not meet the second condition and not trigger the wear leveling operation yet.

In an exemplary embodiment, in response to a wear leveling operation being triggered, in the wear leveling operation, the memory management circuit 51 may move valid data in at least one physical unit (also referred to as a second physical unit) in the rewritable non-volatile memory module 43 to at least one of the plurality of first physical units. In particular, the wear count value corresponding to each of the second physical units (also referred to as a second wear count value) is less than the wear count value corresponding to each of the first physical units (that is, the first wear count value).

In an exemplary embodiment, in a wear leveling operation, valid data stored in the physical unit having a relatively lower wear count value (that is, the second physical unit) is moved (including copied) to the physical unit having a relatively higher wear count value (that is, the first physical unit) for storage. Thereafter, the physical unit having a relatively lower wear count value (that is, the second physical unit) may be erased and available for writing new data. Therefore, by performing a wear leveling operation, the wear count values corresponding to a plurality of physical units may be brought closer (that is, homogenized or averaged), thus avoiding shortening the service life of the rewritable non-volatile memory module 43 due to excessive use of a specific physical unit.

In an exemplary embodiment, in response to the wear leveling operation being triggered, the memory management circuit 51 may select one or a plurality of physical units that currently store valid data and correspond to the minimum or relatively smaller wear count value as the source node of the valid data (that is, the second physical unit) from the physical units 610(0) to 610(A) of FIG. 6 (that is, the storage area 601) with reference to the distribution of wear count values of the physical units of FIG. 7. At the same time, the memory management circuit 51 may select the physical unit belonging to the first physical unit and corresponding to the maximum or relatively greater wear count value from the physical units 610(A+1) to 610(B) (that is, the spare area 602) of FIG. 6 as the target node of valid data. Then, in the wear leveling operation, the memory management circuit 51 may read the valid data from the source node of the selected valid data and re-store the read valid data into the target node of the valid data.

In an exemplary embodiment, the total of the first physical units meeting the second condition to actively trigger and perform a wear leveling operation may be regarded as performing a wear leveling operation in advance according to the total of the first physical units before the traditional wear leveling mechanism is triggered. Therefore, the need to quickly and frequently perform a wear leveling operation due to the simultaneous detection of a large number of physical units having very high wear count values after a period of time that affect the access performance of the memory storage device 10 or the rewritable non-volatile memory module 43 may be avoided.

In an exemplary embodiment, by performing the wear leveling operation in advance according to the total of the first physical units, the memory management circuit 51 may appropriately adjust the interval time (or wait time) between a plurality of wear leveling operations. During this wait time, the memory management circuit 51 may suspend execution of the wear leveling operation. After the wait time is elapsed, the memory management circuit 51 may continue to perform the next wear leveling operation to move data. Therefore, compared with the traditional need to perform fast and frequent wear leveling operations due to the simultaneous detection of a large number of physical units having very high wear count values, by performing the desired wear leveling operations in advance and in a distributed manner, the adverse impact of the wear leveling operation on the access performance of the memory storage device 10 or the rewritable non-volatile memory module 43 may be reduced (for example, the occupation of the data transmission bandwidth of the memory storage device 10 or the rewritable non-volatile memory module 43 is reduced by the wear leveling operation).

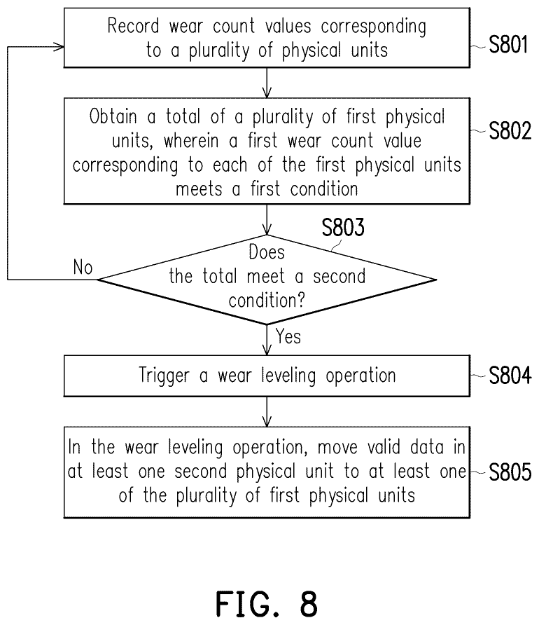

FIG. 8 is a flowchart of a wear leveling method shown according to an exemplary embodiment of the invention. Referring to FIG. 8, in step S801, wear count values respectively corresponding to a plurality of physical units are recorded. In step S802, the total of a plurality of first physical units in the plurality of physical units is obtained. A first wear count value corresponding to each of the first physical units meets a first condition. In step S803, whether the total meets a second condition is determined. If the total meets the second condition, in step S804, a wear leveling operation is triggered. In step S805, in the wear leveling operation, valid data in at least one second physical unit in the plurality of physical units is moved to at least one of the plurality of first physical units. A second wear count value corresponding to each of the second physical units is less than the first wear count value. However, if the total does not meet the second condition, step S801 may be repeated to continuously record and update the wear count values respectively corresponding to the plurality of physical units.

However, each step in FIG. 8 has been described in detail above and will not be described again here. It is worth noting that each step in FIG. 8 may be implemented as a plurality of program codes or circuits, and the invention is not limited thereto. In addition, the method of FIG. 8 may be used in conjunction with the above exemplary embodiments or may be used alone, and is not limited by the invention.

Based on the above, the wear leveling method, the memory storage device, and the memory control circuit unit provided by the exemplary embodiments of the invention may determine whether to trigger the wear leveling operation in advance according to the total of the first physical units. Therefore, the wear leveling operation performed for the rewritable non-volatile memory module may be optimized (including reducing the impact of the wear leveling operation on the data transmission bandwidth of the memory storage device or the rewritable non-volatile memory module), and the service life of the rewritable non-volatile memory module may be extended. Moreover, by setting the first threshold value to be greater than the average wear count value, in conjunction with the setting of the trigger condition for the wear leveling operation provided by the exemplary embodiment of the invention, the frequency with which the wear leveling operation is triggered may be reduced, and/or the number of physical units on which the wear leveling operation is performed each time may be reduced. As a result, the effect of extending the service life of the rewritable non-volatile memory module may also be achieved.

Lastly, it should be noted that the above embodiments are used to describe the technical solution of the disclosure instead of limiting it. Although the disclosure has been described in detail with reference to each embodiment above, those having ordinary skill in the art should understand that the technical solution recited in each embodiment above may still be modified, or some or all of the technical features thereof may be equivalently replaced. These modifications or replacements do not make the essence of the corresponding technical solutions depart from the scope of the technical solution of each embodiment of the disclosure.

What is claimed is:

1. A wear leveling method, used for a rewritable non-volatile memory module, wherein the rewritable non-volatile memory module comprises a plurality of physical units, and the wear leveling method comprises:
recording wear count values respectively corresponding to the plurality of physical units;
obtaining a total of a plurality of first physical units in the plurality of physical units, wherein a first wear count value corresponding to each of the first physical units is greater than a first threshold value;
triggering a wear leveling operation in response to the total being greater than a second threshold value; and
moving valid data in at least one second physical unit in the plurality of physical units to at least one of the plurality of first physical units in the wear leveling operation, wherein a second wear count value corresponding to each of the second physical units is less than the first wear count value.

2. The wear leveling method of claim 1, wherein the first threshold value is between a maximum wear count value and an average wear count value corresponding to the plurality of physical units.

3. The wear leveling method of claim 2, further comprising:
obtaining the maximum wear count value and the average wear count value corresponding to the plurality of physical units;
obtaining a first value according to a difference between the maximum wear count value and the average wear count value, wherein the first value is less than the difference; and
obtaining the first threshold value according to the average wear count value and the first value, wherein a difference between the first threshold value and the average wear count value is controlled by the first value.

4. The wear leveling method of claim 3, wherein the step of obtaining the first value according to the difference between the maximum wear count value and the average wear count value comprises:
dividing the difference by N to obtain the first value, wherein N may be any value greater than 1.

5. The wear leveling method of claim 3, wherein the step of obtaining the first threshold value according to the average wear count value and the first value comprises:
adding the first value to the average wear count value to obtain the first threshold value.

6. The wear leveling method of claim 1, further comprising:
not triggering the wear leveling operation in response to the total being not greater than the second threshold value.

7. A memory storage device, comprising:
a connection interface unit for connecting to a host system;
a rewritable non-volatile memory module comprising a plurality of physical units; and
a memory control circuit unit connected to the connection interface unit and the rewritable non-volatile memory module,
wherein the memory control circuit unit is used for:
recording wear count values respectively corresponding to the plurality of physical units;
obtaining a total of a plurality of first physical units in the plurality of physical units, wherein a first wear count value corresponding to each of the first physical units is greater than a first threshold value;
triggering a wear leveling operation in response to the total being greater than a second threshold value; and
moving valid data in at least one second physical unit in the plurality of physical units to at least one of the plurality of first physical units in the wear leveling operation, wherein a second wear count value corresponding to each of the second physical units is less than the first wear count value.

8. The memory storage device of claim 7, wherein the first threshold value is between a maximum wear count value and an average wear count value corresponding to the plurality of physical units.

9. The memory storage device of claim 8, wherein the memory control circuit unit is further used for:
obtaining the maximum wear count value and the average wear count value corresponding to the plurality of physical units;
obtaining a first value according to a difference between the maximum wear count value and the average wear count value, wherein the first value is less than the difference; and
obtaining the first threshold value according to the average wear count value and the first value, wherein a difference between the first threshold value and the average wear count value is controlled by the first value.

10. The memory storage device of claim 9, wherein the operation of obtaining the first value according to the difference between the maximum wear count value and the average wear count value comprises:
dividing the difference by N to obtain the first value, wherein N may be any value greater than 1.

11. The memory storage device of claim 9, wherein the operation of obtaining the first threshold value according to the average wear count value and the first value comprises:
adding the first value to the average wear count value to obtain the first threshold value.

12. The memory storage device of claim 7, wherein the memory control circuit unit is further used for:
not triggering the wear leveling operation in response to the total being not greater than the second threshold value.

13. A memory control circuit unit, used for controlling a rewritable non-volatile memory module, wherein the rewritable non-volatile memory module comprises a plurality of physical units, and the memory control circuit unit comprises:
a host interface for connecting to a host system;
a memory interface for connecting to the rewritable non-volatile memory module; and
a memory management circuit connected to the host interface and the memory interface,
wherein the memory management circuit is used for:
recording wear count values respectively corresponding to the plurality of physical units;
obtaining a total of a plurality of first physical units in the plurality of physical units, wherein a first wear count value corresponding to each of the first physical units is greater than a first threshold value;
triggering a wear leveling operation in response to the total being greater than a second threshold value; and
moving valid data in at least one second physical unit in the plurality of physical units to at least one of the plurality of first physical units in the wear leveling operation, wherein a second wear count value corresponding to each of the second physical units is less than the first wear count value.

14. The memory control circuit unit of claim 13, wherein the first threshold value is between a maximum wear count value and an average wear count value corresponding to the plurality of physical units.

15. The memory control circuit unit of claim 14, wherein the memory management circuit is further used for:
obtaining the maximum wear count value and the average wear count value corresponding to the plurality of physical units;
obtaining a first value according to a difference between the maximum wear count value and the average wear count value, wherein the first value is less than the difference; and
obtaining the first threshold value according to the average wear count value and the first value, wherein a difference between the first threshold value and the average wear count value is controlled by the first value.

16. The memory control circuit unit of claim 15, wherein the operation of obtaining the first value according to the difference between the maximum wear count value and the average wear count value comprises:
dividing the difference by N to obtain the first value, wherein N may be any value greater than 1.

17. The memory control circuit unit of claim 15, wherein the operation of obtaining the first threshold value according to the average wear count value and the first value comprises:
adding the first value to the average wear count value to obtain the first threshold value.

18. The memory control circuit unit of claim 13, wherein the memory management circuit is further used for:
not triggering the wear leveling operation in response to the total being not greater than the second threshold value.
